(19) United States
(12) Patent Application Publication
(10) Pub. No.: US 2004/0163007 A1
(43) Pub. Date: Aug. 19, 2004

(54) Determining a quantity of lost units resulting from a downtime of a software application or other computer-implemented system

(76) Inventors: Kazem Mirkhani, Washington, MI (US); Sunny F. Coleman, Little Elm, TX (US)

Correspondence Address: CHRISTOPHER W. KENNERLY, BAKERBOTTSLLP., 2001 ROSS AVENUE, 6TH FLOOR, DALLAS, TX, 75201, US

(21) Appl. No.: 10/369,796

(22) Filed: Feb. 19, 2003

(51) Int. Cl. H02H 3/05

(52) U.S. Cl. 714/1

(57) ABSTRACT

In one embodiment, a system for determining a quantity of lost units resulting from an identified downtime of a computer-implemented system includes one or more software components collectively operable to access user quantity information for each of one or more time intervals and access downtime quantity information for the identified downtime. The user quantity information indicates a number of users associated with the computer-implemented system for a time interval, and the downtime quantity information includes a start time and an end time of the identified downtime. The software components calculate the quantity of lost units by: (1) according to the start time and end time, determining one or more particular time intervals associated with the identified downtime; (2) for each particular time interval, determining the number of users impacted; (3) for each particular time interval, determining the quantity of lost units for the particular time interval according to the number of users impacted; and (4) summing the quantity of lost units for each particular time interval over all one or more particular time intervals to determine the quantity of lost units resulting from the identified downtime.

### BACKGROUND OF THE INVENTION

Businesses are generally concerned about productivity and other metrics, which measure factors that may affect the efficient operation of the business. It is often necessary to identify where lost hours or other units are occurring in a business because these lost units frequently mean lost revenue for the business. As an example, a business often relies on software applications to enable its employees to efficiently perform their tasks so that the business may operate more efficiently. However, such software applications may experience downtime that may affect the productivity of the employees, often resulting in lost revenue for the business. A software application may, for example, be unavailable to a number of employees relying on the availability of the software application to perform their jobs. Thus, the related business may experience losses in the number of hours productively worked by its employees. Determining how to measure, track, and decrease the number of lost units incurred due to downtime of software applications or other computer-implemented systems on an organization-wide basis has been problematic.

### SUMMARY OF THE INVENTION

In one embodiment, a system for determining a quantity of lost units resulting from an identified downtime of a computer-implemented system includes one or more software components collectively operable to access user quantity information for each of one or more time intervals. The user quantity information for a time interval indicates a number of users associated with the computer-implemented system for the time interval. The one or more software components are collectively operable to access downtime quantity information for the identified downtime in which the computer-implemented system is unavailable, the downtime quantity information including a start time and an end time of the identified downtime. The one or more software components are collectively operable to, according to the user quantity information and downtime quantity information, calculate the quantity of lost units resulting from the identified downtime by: (1) according to the start time and end time of the identified downtime, determining one or more particular time intervals associated with the identified downtime in which the computer-implemented system is unavailable; (2) for each particular time interval, determining the number of users impacted by the identified downtime according to the accessed user quantity information for the particular time interval; (3) for each particular time interval, determining the quantity of lost units for the particular time interval according to the number of users impacted for the particular time interval; and (4) summing the quantity of lost units for each particular time interval over all one or more particular time intervals to determine the quantity of lost units resulting from the identified downtime.

Particular embodiments of the present invention may provide one or more technical advantages. For example, in one embodiment, the present invention may provide for measuring and tracking the number of lost hours or other units incurred by users due to downtime of software applications or other computer-implemented systems on an organization-wide basis. The present invention may provide a cost-effective process that may be deployable across a large, complex enterprise with many users. Lost units, whether they affect individual users or entire businesses, may lead to lost revenue. The present invention may help a business identify sources of lost revenue resulting from lost units so as to better evaluate alternative software applications, computer systems, networks, and other resources. The present invention may help companies improve problem management and resolution with regard to lost units.

As an example, a financial services provider may rely on a variety of software applications or other computer-implemented systems to generate millions of electronic pages of statements, checks, notices, reports, and year-end forms for its customers, and it may be critical to track lost units due to downtime of such software applications or other computer-implemented systems. Because of the highly critical nature of these documents, it may be desirable to design a highly secure archiving method as well as the ability to quickly retrieve documents in order to answer questions raised by the financial services provider's customers. The present invention may help quantify lost units due to software application or other computer-implemented system downtime and may provide critical information for design and management of such services. The present invention may also help fulfill governmental requirements in certain countries that require end-to-end monitoring of the performance of software applications and other computer-implemented systems.

Certain embodiments of the present invention may provide some, all, or none of the above technical advantages. Certain embodiments may provide one or more other technical advantages, one or more of which may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates an example system for determining a quantity of lost units resulting from a downtime of a software application or other computer-implemented system;

FIG. 2 illustrates an example method for determining a quantity of lost units resulting from a downtime of a software application or other computer-implemented system;

FIG. 3 illustrates an example user quantity information table that may be used to calculate the quantity of lost units resulting from an identified downtime of a software application or other computer-implemented system; and

FIG. 4 illustrates an example lost units report.

### DESCRIPTION OF EXAMPLE EMBODIMENTS

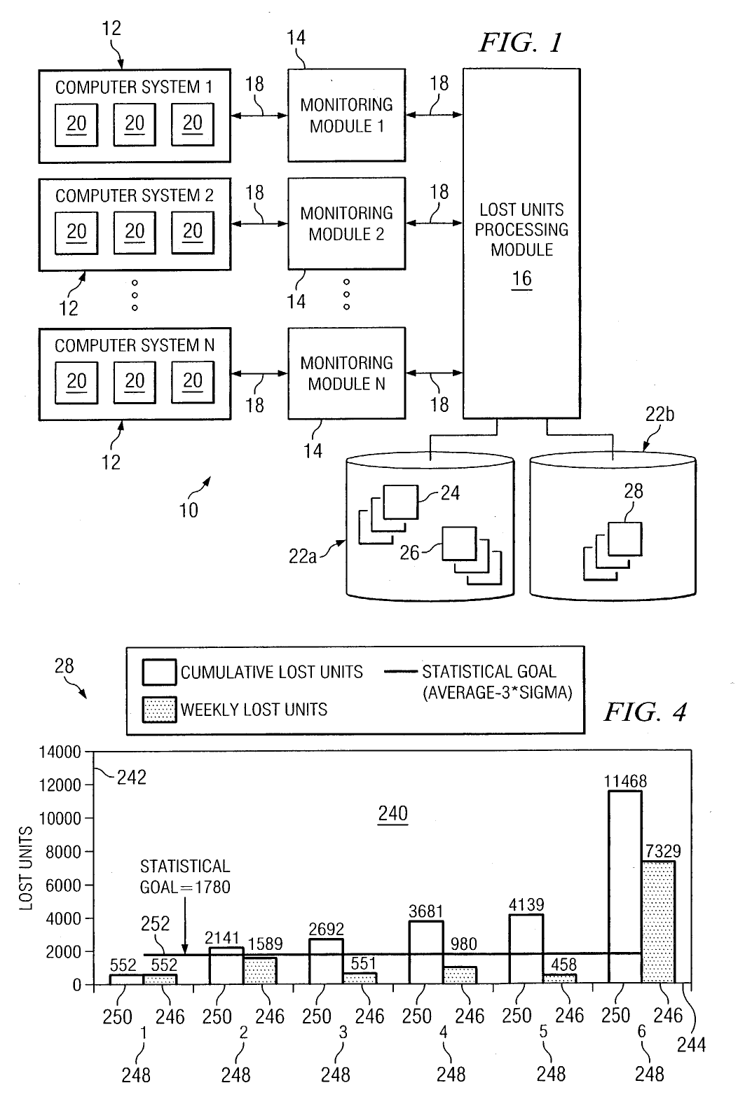

FIG. 1 illustrates an example system 10 for determining a quantity of lost units resulting from a downtime of a software application or other computer-implemented system. In one embodiment, system 10 includes one or more computer systems 12 in communication with one or more monitoring modules 14, each of which may be in communication with a lost units processing module 16. Computer systems 12, monitoring modules 14, and lost units processing module 16 may be coupled to one another using links 18 that may each include one or more computer buses, one or more local area networks (LANs), one or more metropolitan area networks (MANs), one or more wide area networks (WANs), at least a portion of a global computer network such as the Internet, or one or more other suitable wireline, optical, wireless, or other links. Computer systems 12, monitoring modules 14, and lost units processing module 16 may each operate on one or more computer systems at one or more physical locations. Although computer systems 12, monitoring modules 14, and lost units processing module 16 are described primarily as being separate, computer systems 12, monitoring modules 14, and lost units processing module 16 may share one or more computer resources or other appropriate resources according to particular needs. For example, one or more monitoring modules 14 may operate on the same computer system as lost units processing module 16.

Each computer system 12 supports one or more software applications 20 that may be accessed and operated by associated users. As an example, computer systems 12 may be associated with an enterprise and the users may be employees of the enterprise. In this example, software applications 20 may include software applications that employees access and use to perform their jobs for the enterprise. Each software application 20 may be operated by one or more human users or may be operated autonomously according to input from one or more computers internal or external to the associated computer system 12. Where appropriate, reference to “users” is meant to encompass both human users and autonomous computer users of software applications 20. Although software applications 20 are primarily described, the present invention contemplates determining a quantity of lost units resulting from a downtime of any suitable computer-implemented system. For example, the present invention contemplates determining a quantity of lost units resulting from downtimes of different computers within computer system 12, different computer subsystems within computer system 12, different computer systems 12, or any other computer-implemented systems.

Monitoring modules 14 may each include one or more software components running on one or more associated computer systems at one or more physical locations. A monitoring module 14 may be associated with a single computer system 12 (as shown) or multiple computer systems 12. A monitoring module 14 may access user quantity information for each of one or more time intervals for each software application 20 associated with the monitoring module 14. In one embodiment, the user quantity information for a time interval indicates the number of users associated with software application 20 for the time interval. For example, the user quantity information may indicate the number of human users actually using software application 20 during the time interval, expected to be using software application 20 during the time interval based on historical information, or otherwise associated with software application 20 for the time interval. As another example, the user quantity information may indicate the number of computer users actually autonomously using software application 20 during the time interval, expected to be using software application 20 during the time interval based on historical information, or otherwise associated with software application 20 for the time interval. The time intervals may include months, weeks, days, hours, minutes, or any other suitable time intervals. For example, the user quantity information may indicate the number of users associated with software application 20 each hour.

In one embodiment, monitoring module 14 may determine the number of users of an associated software application 20 using a monitoring tool. In one embodiment, the monitoring tool includes NETIQ WEBTRENDS software to access the user quantity information of an associated software application 20. The monitoring tool may allow the user quantity information to be updated on a real-time basis, a periodic basis, or on any other suitable basis. For example, monitoring module 14 may use the monitoring tool to access an associated software application 20 once per hour to determine the number of users that are actually using software application 20 during that hour. As another example, monitoring module 14 may use the monitoring tool to access an associated software application 20 once every minute to determine the number of users actually using software application 20 during that minute, providing more precise measurements of the number of users of software application 20. Monitoring module 14 may then compute the average number of users of software application 20 for an hour based on the number of users for each minute in the hour.

In another embodiment, monitoring module 14 may determine the number of users of an associated software application 20 using a predefined statistical procedure. The predefined statistical procedure may be based on a statistical sampling of past actual or estimated user quantity information to determine the number of users associated with software application 20 at one or more time intervals. This past user quantity information may be used to determine future user quantity information, for example, to estimate the number of users associated with software application 20 at one or more time intervals in the future. The predefined statistical procedure may include periodically polling users to accumulate data to be used in estimating the number of users associated with software application 20 at one or more time intervals. These estimates may be based on minutes, hours, days, or any other suitable time intervals. In an example where the users of software application 20 are employees, the estimates may also reflect various other factors such as the total number of employees with access to software application 20, the particular day of the week, the particular date, the average number of sick users per day, the average number of users on vacation per day or for the particular date, the time of day, and any other suitable factors, individually or in any suitable combination. The estimates may also be specific to the type of software application 20. For example, if software application 20 is a time-tracking software application, it may be desirable to increase the estimated number of users associated with the time-tracking software on Friday afternoons because employees frequently enter their time for the week on Friday afternoon. The statistical sampling may be periodically updated and recorded in one or more tables stored in a database. For example, the statistical sampling data may be updated on a scheduled basis, such as once a month.

A software application 20 may be associated with an application downtime. An application downtime may generally include any period of time in which software application 20 is unavailable. As an example, an application downtime may include a time period during which software application 20 is not working properly, such that users of software application 20 may not be able to properly use software application 20. As another example, an application downtime may include a time period during which computer system 12 is not working properly, such that users of computer system 12 may not be able to properly access software application 20. As another example, an application downtime may include a period of time during which network connections by which users access software application 20 are not functioning properly, such that users of software application 20 cannot access software application 20. In one embodiment, an application downtime may be reported to the monitoring module 14 associated with software application 20 by a human responsible for monitoring software application 20 or associated computer system 12, such as an information technology employee. In another embodiment, monitoring module 14 may use a monitoring tool to identify an application downtime of an associated software application 20. Monitoring module 14 may access downtime quantity information for an identified application downtime in which a software application 20 is unavailable. The downtime quantity information may include a start time and an end time of the identified application downtime.

In one embodiment, it may be preferable to exclude certain types of application downtimes from identified application downtimes. For example, it may be preferable to exclude time for which software application 20 is unavailable due to a scheduled upgrade of software application 20 or scheduled maintenance of computer system 12. However, including such times as identified application downtimes may provide a good way to determine the cost of such upgrades or maintenance in terms of lost units. As another example, it may be preferable to exclude redundant system failure downtimes. Redundant system failure downtime may include downtime that has no impact on the ability of users to access software application 20 because of technical redundancy functionality that enabled computer system 12 to dynamically switch to a secondary or other alternative software application 20. As another example, it may be preferable to exclude the application response time of a software application 20, which may include the time period between the time the user hits the enter key or clicks the mouse and the time a response is sent to the user for example. In other embodiments, an identified application downtime may be defined as any period of time in which software application 20 is unavailable, regardless of the reason.

Lost units processing module 16 may include one or more software components running on one or more associated computer systems at one or more physical locations. Lost units processing module 16 may calculate the quantity of lost units resulting from an identified application downtime for a software application 20 according to appropriate user quantity information and downtime quantity information. Lost units processing module 16 may receive user quantity information and downtime quantity information from a monitoring module 14 associated with software application 20. In one embodiment, lost units processing module 16 is coupled to one or more databases 22 for storing information related to determining quantities of lost units resulting from identified application downtimes of software applications 20. Although databases 22 are described as databases, databases 22 may include any memory structure suitable for storing data. In one embodiment, lost units processing module 16 is coupled to a database 22a, which may store user quantity information tables 24 and downtime quantity information tables 26. For example, if the user quantity information includes estimates based on statistical sampling of the number of users associated with a software application 20 for one or more time intervals, the user quantity information may be stored in user quantity information tables 24. The estimates may be periodically updated as discussed above and user quantity information tables 24 may be changed to reflect these updates. As another example, if monitoring module 14 uses a monitoring tool to determine the number of users associated with a software application 20, user quantity information tables 24 may be updated in substantially real time to reflect the user quantity information determined by the monitoring tools.

In one embodiment, to calculate the quantity of lost units resulting from an identified application downtime for a software application 20, lost units processing module 16 may determine one or more particular time intervals associated with the identified application downtime according to the start time and end time of the identified application downtime reflected in the downtime quantity information. For example, lost units processing module 16 may compare the start time and end time of the identified application downtime to one or more time intervals of the user quantity information to determine the one or more particular time intervals in which the identified application downtime occurred. For each particular time interval, lost units processing module 16 may determine the number of users impacted according to the accessed user quantity information for the particular time interval. For each particular time interval, lost units processing module 16 may determine the quantity of lost units for the particular time interval. In one embodiment, to determine the quantity of lost units for a particular time interval, lost units processing module 16 may determine a percentage of the particular time interval in which software application 20 is unavailable and multiply the determined percentage by the number of users for the particular time interval to calculate the quantity of lost units for the particular time interval. In another embodiment, lost units processing module 16 may simply assume the identified application downtime spans the entire particular time intervals, such that the quantity of lost units for the particular time interval equals the number of users for the particular time interval. The present invention contemplates determining the quantity of lost units for each particular time interval in any suitable manner. Lost units processing module 16 may sum the quantity of lost units for each particular time interval over all particular time intervals to determine the quantity of lost units resulting from the identified downtime.

In one embodiment, lost units processing module 16 may compute quantities of lost units for multiple identified application downtimes for multiple software applications 20 associated with multiple computer systems 12. For example, lost units processing module 16 may calculate quantities of lost units according to the following formula:

$$Lost units = {\sum }_{j = 1}^{m} {\sum }_{i = 1}^{n} DTij * NUij$$

In one embodiment, the variable i may represent an index of different software applications 20. However, as discussed above, although software applications 20 are primarily described, the present invention contemplates determining a quantity of lost units resulting from any suitable computer-implemented systems. The variable n may represent a total number of software applications 20. For example, n may represent the total number of software applications 20 in a particular area of an enterprise such as software applications 20 that support financial systems for the enterprise. The variable j may represent an index of different identified application downtimes. The variable m may represent a total number of identified application downtimes across all software applications 20. The variable DT may represent the duration of identified application downtime j for the ith software application 20. The variable NU may represent the number of users, as indicated in the accessed user quantity information, impacted by identified application downtime j for the ith software application 20.

As another example, lost units processing module 16 may calculate weekly quantities of lost hours according to the following formula:

$$\begin{matrix}Lost units = ( Weekly Users Affected ) * \\ ( 1 - Availability ) * \\ ( Hours Available for Week )\end{matrix}$$

As yet another example, lost units processing module 16 may calculate monthly quantities of lost hours according to the following formula:

$$\begin{matrix}Lost units = ( identified application downtimes per month ) * \\ ( average length of identified application downtimes \\ in hours ) * \\ ( average number of users impacted per identified \\ application downtime )\end{matrix}$$

Lost units processing module 16 may generate one or more lost units reports 28 and may store the lost units reports 28 in a database 22b. An example lost units report is described below with reference to FIG. 4.

Particular embodiments of the present invention may provide one or more technical advantages. For example, in one embodiment, the present invention may provide for measuring and tracking the number of lost hours or other units incurred by users due to downtime of software applications 20 or other computer-implemented systems on an organization-wide basis. The present invention may provide a cost-effective process that may be deployable across a large, complex enterprise with many users. Lost units, whether they affect individual users or entire businesses, may lead to lost revenue. The present invention may help a business identify sources of lost revenue resulting from lost units so as to better evaluate alternative software applications 20, computer systems 12, networks, and other resources. The present invention may help companies improve problem management and resolution with regard to lost units.

As an example, a financial services provider may rely on a variety of software applications 20 or other computer-implemented systems to generate millions of electronic pages of statements, checks, notices, reports, and year-end forms for its customers, and it may be critical to track lost units due to downtime of such software applications 20 or other computer-implemented systems. Because of the highly critical nature of these documents, it may be desirable to design a highly secure archiving method as well as the ability to quickly retrieve documents in order to answer questions raised by the financial services provider's customers. The present invention may help quantify lost units due to software application 20 or other computer-implemented system downtime and may provide critical information for design and management of such services. The present invention may also help fulfill governmental requirements in certain countries that require end-to-end monitoring of the performance of software applications 20 and other computer-implemented systems.

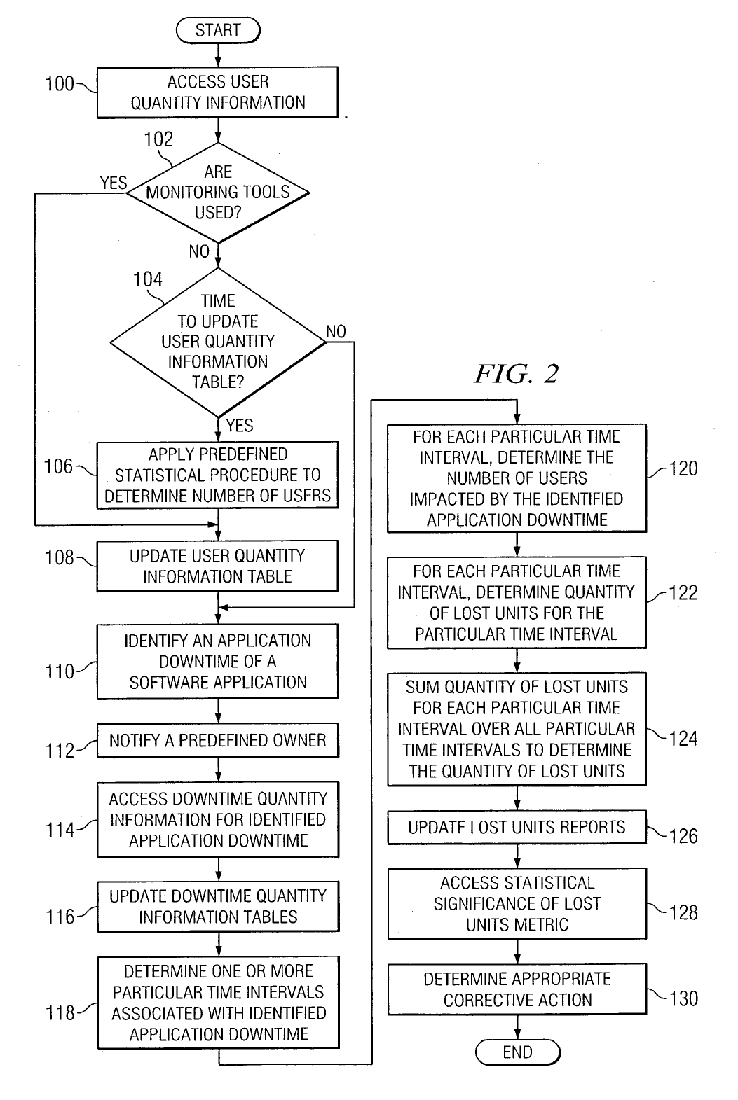

FIG. 2 illustrates an example method for determining a quantity of lost units resulting from a downtime of a software application 20 or computer-implemented system. Although software applications 20 are primarily described, the present invention contemplates determining a quantity of lost units resulting from a downtime of any suitable computer-implemented system. At step 100, monitoring module 14 may access user quantity information for each of one or more time intervals for each software application 20 associated with monitoring module 14. The user quantity information for a time interval may indicate the number of users associated with software application 20 for the time interval. At step 102, if monitoring module 14 is using a monitoring tool to determine the number of users of an associated software application 20, then the method proceeds to step 108, where monitoring module 14 uses the monitoring tool to update user quantity information table 24. If monitoring module is not using a monitoring tool at step 102, and it is time to use the predefined statistical procedure to update user quantity information table 24 at step 104, then the predefined statistical procedure is applied at step 106 to determine the number of users associated with software application 20 and user quantity information table 24 is updated at step 108. If it is not time to use the predefined statistical procedure at step 104, then the method proceeds to step 110.

At step 110, an application downtime of software application 20 is identified. In one embodiment, an identified application downtime may be reported to monitoring module 14 by a human monitoring software application 20 or associated computer system 12, such as an information technology employee. In another embodiment, monitoring module 14 may use a monitoring tool to identify an application downtime. At step 112, monitoring module 14 may notify a predefined owner or other person responsible for software application 20 of the identified application downtime. At step 114, monitoring module 14 may access downtime quantity information for the identified application downtime. The downtime quantity information may include a start time and an end time of the identified application downtime. At step 116, monitoring module 14 may update downtime quantity information tables 26 to reflect the downtime quantity information for the identified application downtime.

At steps 118 through 124, lost units processing module 16 may calculate the quantity of lost units resulting from the identified application downtime. In one embodiment, the lost units are lost hours. At step 118, lost units processing module 16 may determine one or more particular time intervals associated with the identified application downtime. For each particular time interval, lost units processing module 16 may determine the number of users impacted for each of the time intervals at step 120. For each particular time interval, lost units processing module 16 may determine the quantity of lost units for the particular time interval at step 122. In one embodiment, to determine the quantity of lost units for a particular time interval, lost units processing module 16 may determine a percentage of the particular time interval in which software application 20 is unavailable and multiply the determined percentage by the number of users for the particular time interval to calculate the quantity of lost units for the particular time interval. In another embodiment, lost units processing module 16 may simply assume the identified application downtime spans the entire particular time intervals, such that the quantity of lost units for the particular time interval equals the number of users for the particular time interval. The present invention contemplates determining the quantity of lost units for each particular time interval in any suitable manner. At step 126, lost units processing module 16 may sum the quantity of lost units for each particular time interval over all the particular time intervals to determine the quantity of lost units resulting from the identified application downtime of software application 20. Lost units processing module 16 may generate or update lost units reports 28 at step 126.

At step 128, lost units processing module 16 may assess the statistical significance of the lost units metric determined at steps 118 through 124. In one embodiment, assessing the statistical significance includes applying a statistical procedure to assess performance based on “six-sigma” criteria. At step 130, an appropriate corrective action may be determined. The actual quantity of lost units and the statistical significance of the lost units metric may be considered in determining what appropriate corrective action, if any, should be taken. Such corrective action may include upgrading software application 20 or associated computer system 12, replacing software application 20 or associated computer system 12, or any other appropriate corrective action.

Although the above description describes lost units processing module 16 receiving information from one monitoring module 14 monitoring an associated software application 20, the present invention encompasses determining for each of a plurality of software applications 20 running on a plurality of computer systems 12 the quantity of lost units resulting from identified application downtimes of the software applications 20 or computer systems 12. For example, a single monitoring module 14 may access user quantity information and downtime quantity information for multiple computer systems 12 and associated software applications 20. As another example, each monitoring module 14 may be associated with a single computer system 12 and may access user quantity information and downtime quantity information for its associated computer system 12 and the software applications 20 running on its associated computer system 12. Lost units processing module 16 may sum the quantity of lost units determined for each computer system 12 and software application 20, according to particular needs.

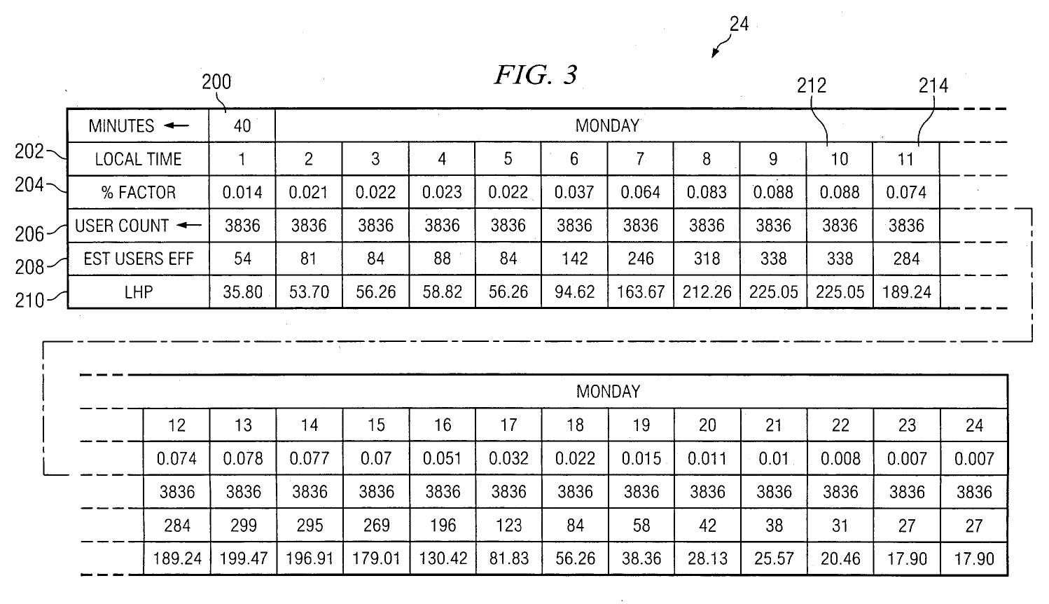

FIG. 3 illustrates an example user quantity information table 24 that may be stored in database 22a and used by lost units processing module 16 to calculate the quantity of lost units resulting from an identified application downtime 200. In one embodiments, lost units processing module 16 may use any suitable number of user quantity information tables 24 based upon statistical samples, information obtained using monitoring tools associated with monitoring modules 14, or any other suitable information to determine the number of users associated with computer system 12 at one or more time intervals. Example user quantity information table 24 illustrates user quantity information for an example Monday. As illustrated in row 202, the day is divided into twenty-four time intervals each representing one hour of the day. For example, assume hour one represents 12:01-1:00 A.M., hour two represents 1:01-2:00 A.M., and so on. In one embodiment, user quantity information table 24 may be updated in substantially real time if monitoring modules 14 use monitoring tools to automatically access user quantity information. In another embodiment, user quantity information table 24 may be periodically updated according to any suitable schedule for applying the predefined statistical procedure for determining the number of users of a software application 20. Row 204 may include a percentage factor for each hour, which may be used to weight each hour according to the number of users of software application 20 during that hour. For example, during hour one (the 12:00-1:00 A.M. hour), the percentage factor may be relatively low (0.014) to reflect the fact that relatively few users would likely be using software application 20 at that hour. As another example, during hour ten (the 9:01-10:00 A.M. hour), the percentage factor may be higher (0.088) to reflect the possibility that many people are arriving at work and beginning to use software application 20. Use of such a percentage factor may be particularly desirable when user quantity information is based upon statistical samples rather than more precise data obtained using monitoring tools.

Row 206 may include a user count for each hour, which may indicate the total number of users using software application 20 during that hour. The precision of this number may vary depending on whether user quantity information tables 24 are based upon statistical samples or information obtained using monitoring tools and the precision associated with such statistical samples or information. Row 208 may include a number of users affected by identified application downtime 200 for each hour, assuming the entire identified application downtime 200 occurs during that hour. In one embodiment, where user quantity information tables 24 are based on statistical samples, the number of users indicated in row 208 may be an estimated number of users affected by identified application downtime 200. For example, the estimated number of users affected may be calculated by multiplying the percentage factor for a particular time interval (e.g., 0.088 for hour ten) by the user count contained in row 206 for the particular time interval (e.g., 3836 for hour ten, yielding 0.088*3836=338). Row 210 may include the quantity of lost hours resulting from identified application downtime 200. For example, the estimated number of users affected for a particular time interval (e.g., 338 for hour ten) may be multiplied by the number of minutes in identified application downtime 200 (e.g., 40) to compute the total number of lost minutes resulting from identified application downtime 200 (e.g., 338*40=13,520 for hour ten). The total number of lost minutes may be divided by sixty to convert to lost hours (e.g., 13,520/60=225.05 for hour ten). Alternatively, the identified application downtime 200 may be expressed in hours (e.g., 0.667), and the calculations may be adjusted accordingly.

An identified application downtime 200 may be associated with any number of adjacent intervals, depending on the start time and end time indicated in the downtime quantity information for the identified application downtime 200. As a simple example, the downtime quantity information for identified application downtime 200 may indicate a start time of 9:40 A.M. and an end time of 10:20 A.M. Thus, identified application downtime 200 may be divided between time interval 212 (hour ten) and time interval 214 (hour eleven), occupying twenty minutes in each time interval. Because the percentage factors for each time interval may be different, it may be necessary to determine the number of users impacted according to the accessed user quantity information for each time interval 212 and 214, for example, according to the percentage of the identified accessed downtime falling in each time interval. Thus, in this example, the estimated number of users affected in time interval 212 (338 users) may be multiplied by the number of minutes of identified application downtime 200 falling in time interval 212 (20 minutes) and the result divided by sixty to determine the quantity of lost hours for time interval 212 (112.66 hours). In addition, the estimated number of users affected in time interval 214 (284 users) may be multiplied by the number of minutes of identified application downtime 200 falling in time interval 214 (20 minutes) and the result divided by sixty to determine the quantity of lost hours for time interval 214 (94.66 hours). The quantity of lost hours for time interval 212 (112.66 hours) and the quantity of lost hours for time interval 214 (94.66 hours) may then be summed to determine the total number of lost hours (207.32 hours) resulting from identified application downtime 200. In one embodiment, a human user associated with lost units processing module 16 may perform these calculations. In another embodiment, lost units processing module 16 automatically performs the necessary calculations to determine the quantity of lost units resulting from identified application downtime 200.

FIG. 4 illustrates an example lost units report 28, which may be generated by lost units processing module 16 and stored in database 22b. Lost units report 28 may include one or more bar graphs 240. A vertical axis 242 of bar graph 240 may represent the quantity of lost units, such as lost hours for example. A horizontal axis 244 of bar graph 240 may represent various dates, times, software applications 20, or any other suitable variables according to particular needs. In the illustrated example, each bar graph 240 may include a weekly number of lost units 246 for a corresponding time interval 248 and a cumulative number of lost units 250 for the corresponding time interval 248. In one embodiment, bar graph 240 may include a statistical bar 252 indicating a three sigma quality level for example. Statistical bar 252 may be used in determining what corrective action to take, if any, with respect to the quantity of lost units calculated by lost units processing module 16.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A system for determining a quantity of lost units resulting from an identified downtime of a computer-implemented system, the system comprising one or more software components collectively operable to:
access user quantity information for each of one or more time intervals, the user quantity information for a time interval indicating a number of users associated with the computer-implemented system for the time interval;
access downtime quantity information for the identified downtime in which the computer-implemented system is unavailable, the downtime quantity information comprising a start time and an end time of the identified downtime; and
according to the user quantity information and downtime quantity information, calculate the quantity of lost units resulting from the identified downtime by:
according to the start time and end time of the identified downtime, determining one or more particular time intervals associated with the identified downtime in which the computer-implemented system is unavailable;
for each particular time interval, determining the number of users impacted by the identified downtime according to the accessed user quantity information for the particular time interval;
for each particular time interval, determining the quantity of lost units for the particular time interval according to the number of users impacted for the particular time interval; and
summing the quantity of lost units for each particular time interval over all one or more particular time intervals to determine the quantity of lost units resulting from the identified downtime.

2. The system of claim 1, wherein the computer-implemented system comprises a software application and the identified downtime comprises an identified downtime of the software application.

3. The system of claim 2, wherein the identified application downtime comprises one of:
a period of time during which the software application is not working properly;
a period of time during which a computer system supporting the software application is not working properly; and
a period of time during which a communication link by which users access the software application is not working properly.

4. The system of claim 1, further comprising determining the quantity of lost units resulting from identified downtimes across an organization by:
determining for each of a plurality of computer-implemented systems the quantity of lost units resulting from one or more identified downtimes of the computer-implemented system; and
summing the determined quantities of lost units.

5. The system of claim 1, further operable to generate a lost units report comprising a graph comprising:
on a horizontal axis, one or more identified downtimes;
on a vertical axis, the quantity of lost units determined for each identified downtime on the horizontal axis; and
a line extending from the vertical axis across the graph indicating a statistical quality level of the determined quantities of lost units.

6. The system of claim 1, wherein the accessed user quantity information for a time interval indicates a number of users determined to be actually using the computer-implemented system during the time interval.

7. The system of claim 1, wherein the number of users associated with the computer-implemented system for a time interval is based on a historical statistical sampling of the number of users of the computer-implemented system, the statistical sampling being periodically updated and stored in a database.

8. The system of claim 1, further comprising determining the quantity of lost units for a particular time interval by:
determining a percentage of the particular time interval in which the computer-implemented system is unavailable; and
multiplying the determined percentage by the number of users impacted for the particular time interval to calculate the quantity of lost units for the particular time interval.

9. The system of claim 1, wherein:
the users comprise human users; and
the lost units comprise lost hours.

10. The system of claim 1, wherein the one or more software components are collectively operable to automatically, without human intervention:
access the user quantity information for each of the time intervals;
access the downtime quantity information for the identified downtime; and
according to the user quantity information and downtime quantity information, calculate the quantity of lost units resulting from the identified downtime.

11. The system of claim 1, comprising:
a monitoring module in communication with the computer-implemented system, the monitoring module operable to access the user quantity information for each of the time intervals and access the downtime quantity information for the identified downtime; and
a lost units processing module in communication with the monitoring module, the lost units processing module operable to, according to the user quantity information and downtime quantity information, calculate the quantity of lost units resulting from the identified downtime.

12. The system of claim 1, wherein the one or more software components are further collectively operable to apply a statistical procedure to assess performance based on the quantity of lost units.

13. A method for determining a quantity of lost units resulting from an identified downtime of a computer-implemented system, comprising:
accessing user quantity information for each of one or more time intervals, the user quantity information for a time interval indicating a number of users associated with the computer-implemented system for the time interval;
accessing downtime quantity information for the identified downtime in which the computer-implemented system is unavailable, the downtime quantity information comprising a start time and an end time of the identified downtime; and
according to the user quantity information and downtime quantity information, calculating the quantity of lost units resulting from the identified downtime by:
according to the start time and end time of the identified downtime, determining one or more particular time intervals associated with the identified downtime in which the computer-implemented system is unavailable;
for each particular time interval, determining the number of users impacted by the identified downtime according to the accessed user quantity information for the particular time interval;
for each particular time interval, determining the quantity of lost units for the particular time interval according to the number of users impacted for the particular time interval; and
summing the quantity of lost units for each particular time interval over all one or more particular time intervals to determine the quantity of lost units resulting from the identified downtime.

14. The method of claim 13, wherein the computer-implemented system comprises a software application and the identified downtime comprises an identified downtime of the software application.

15. The method of claim 14, wherein the identified application downtime comprises one of:
a period of time during which the software application is not working properly;
a period of time during which a computer system supporting the software application is not working properly; and
a period of time during which a communication link by which users access the software application is not working properly.

16. The method of claim 13, further comprising determining the quantity of lost units resulting from identified downtimes across an organization by:
determining for each of a plurality of computer-implemented systems the quantity of lost units resulting from one or more identified downtimes of the computer-implemented system; and
summing the determined quantities of lost units.

17. The method of claim 13, further comprising generating a lost units report comprising a graph comprising:
on a horizontal axis, one or more identified downtimes;
on a vertical axis, the quantity of lost units determined for each identified downtime on the horizontal axis; and
a line extending from the vertical axis across the graph indicating a statistical quality level of the determined quantities of lost units.

18. The method of claim 13, wherein the accessed user quantity information for a time interval indicates a number of users determined to be actually using the computer-implemented system during the time interval.

19. The method of claim 13, wherein the number of users associated with the computer-implemented system for a time interval is based on a historical statistical sampling of the number of users of the computer-implemented system, the statistical sampling being periodically updated and stored in a database.

20. The method of claim 13, further comprising determining the quantity of lost units for a particular time interval by:
determining a percentage of the particular time interval in which the computer-implemented system is unavailable; and
multiplying the determined percentage by the number of users impacted for the particular time interval to calculate the quantity of lost units for the particular time interval.

21. The method of claim 13, wherein:
the users comprise human users; and
the lost units comprise lost hours.

22. The method of claim 13, comprising automatically, without human intervention:
accessing the user quantity information for each of the time intervals;
accessing the downtime quantity information for the identified downtime; and
according to the user quantity information and downtime quantity information, calculating the quantity of lost units resulting from the identified downtime.

23. The method of claim 13, comprising:
accessing the user quantity information for each of the time intervals and accessing the downtime quantity information for the identified downtime using a monitoring module in communication with the computer-implemented system; and
according to the user quantity information and downtime quantity information, calculating the quantity of lost units resulting from the identified downtime using a lost units processing module in communication with the monitoring module.

24. The method of claim 13, further comprising applying a statistical procedure to assess performance based on the quantity of lost units.

25. Software for determining a quantity of lost units resulting from an identified downtime of a computer-implemented system, the software being embodied in computer readable media and when executed operable to:
access user quantity information for each of one or more time intervals, the user quantity information for a time interval indicating a number of users associated with the computer-implemented system for the time interval;
access downtime quantity information for the identified downtime in which the computer-implemented system is unavailable, the downtime quantity information comprising a start time and an end time of the identified downtime; and
according to the user quantity information and downtime quantity information, calculate the quantity of lost units resulting from the identified downtime by:
according to the start time and end time of the identified downtime, determining one or more particular time intervals associated with the identified downtime in which the computer-implemented system is unavailable;
for each particular time interval, determining the number of users impacted by the identified downtime according to the accessed user quantity information for the particular time interval;
for each particular time interval, determining the quantity of lost units for the particular time interval according to the number of users impacted for the particular time interval; and
summing the quantity of lost units for each particular time interval over all one or more particular time intervals to determine the quantity of lost units resulting from the identified downtime.

26. The software of claim 25, wherein the computer-implemented system comprises a software application and the identified downtime comprises an identified downtime of the software application.

27. The software of claim 26, wherein the identified application downtime comprises one of:
a period of time during which the software application is not working properly;
a period of time during which a computer system supporting the software application is not working properly; and
a period of time during which a communication link by which users access the software application is not working properly.

28. The software of claim 25, further operable to determine the quantity of lost units resulting from identified downtimes across an organization by:
determining for each of a plurality of computer-implemented systems the quantity of lost units resulting from one or more identified downtimes of the computer-implemented system; and
summing the determined quantities of lost units.

29. The software of claim 25, further operable to generate a lost units report comprising a graph comprising:
on a horizontal axis, one or more identified downtimes;
on a vertical axis, the quantity of lost units determined for each identified downtime on the horizontal axis; and
a line extending from the vertical axis across the graph indicating a statistical quality level of the determined quantities of lost units.

30. The software of claim 25, wherein the accessed user quantity information for a time interval indicates a number of users determined to be actually using the computer-implemented system during the time interval.

31. The software of claim 25, wherein the number of users associated with the computer-implemented system for a time interval is based on a historical statistical sampling of the number of users of the computer-implemented system, the statistical sampling being periodically updated and stored in a database.

32. The software of claim 25, further operable to determine the quantity of lost units for a particular time interval by:
determining a percentage of the particular time interval in which the computer-implemented system is unavailable; and
multiplying the determined percentage by the number of users impacted for the particular time interval to calculate the quantity of lost units for the particular time interval.

33. The software of claim 25, wherein:
the users comprise human users; and
the lost units comprise lost hours.

34. The software of claim 25, further operable to automatically, without human intervention:
access the user quantity information for each of the time intervals;
access the downtime quantity information for the identified downtime; and
according to the user quantity information and downtime quantity information, calculate the quantity of lost units resulting from the identified downtime.

35. The software of claim 25, operable to:
access the user quantity information for each of the time intervals and access the downtime quantity information for the identified downtime using a monitoring module in communication with the computer-implemented system; and
according to the user quantity information and downtime quantity information, calculate the quantity of lost units resulting from the identified downtime using a lost units processing module in communication with the monitoring module.

36. The software of claim 25, further operable to apply a statistical procedure to assess performance based on the quantity of lost units.

37. A system for determining a quantity of lost units resulting from an identified downtime of a computer-implemented system, comprising:
means for accessing user quantity information for each of one or more time intervals, the user quantity information for a time interval indicating a number of users associated with the computer-implemented system for the time interval;
means for accessing downtime quantity information for the identified downtime in which the computer-implemented system is unavailable, the downtime quantity information comprising a start time and an end time of the identified downtime; and
means for, according to the user quantity information and downtime quantity information, calculating the quantity of lost units resulting from the identified downtime by:
according to the start time and end time of the identified downtime, determining one or more particular time intervals associated with the identified downtime in which the computer-implemented system is unavailable;
for each particular time interval, determining the number of users impacted by the identified downtime according to the accessed user quantity information for the particular time interval;
for each particular time interval, determining the quantity of lost units for the particular time interval according to the number of users impacted for the particular time interval; and
summing the quantity of lost units for each particular time interval over all one or more particular time intervals to determine the quantity of lost units resulting from the identified downtime.

38. A system for determining a quantity of lost units resulting from an identified downtime of a computer-implemented system, the system comprising one or more software components collectively operable to:
automatically and without human intervention, access user quantity information for each of one or more time intervals, the user quantity information for a time interval indicating a number of users associated with the computer-implemented system for the time interval;
automatically and without human intervention, access downtime quantity information for the identified downtime in which the computer-implemented system is unavailable, the downtime quantity information comprising a start time and an end time of the identified downtime; and
according to the user quantity information and downtime quantity information, automatically and without human intervention, calculate the quantity of lost units resulting from the identified downtime by:
according to the start time and end time of the identified downtime, determining one or more particular time intervals associated with the identified downtime in which the computer-implemented system is unavailable;
for each particular time interval, determining the number of users impacted by the identified downtime according to the accessed user quantity information for the particular time interval;
for each particular time interval, determining the quantity of lost units for the particular time interval according to the number of users impacted for the particular time interval by:
determining a percentage of the particular time interval in which the computer-implemented system is unavailable; and
multiplying the determined percentage by the number of users impacted for the particular time interval to calculate the quantity of lost units for the particular time interval; and
summing the quantity of lost units for each particular time interval over all one or more particular time intervals to determine the quantity of lost units resulting from the identified downtime.
